(19) United States
(12) Patent Application Publication
(10) Pub. No.: US 2004/0187265 A1
(43) Pub. Date: Sep. 30, 2004

(54) Clip-on handle

(76) Inventor: Ichen Chawn Ho, Arcadia, CA (US)

Correspondence Address: JOE NIEH, 18760 E. AMAR ROAD #204, WALNUT, CA, 91789, US

(21) Appl. No.: 10/402,497

(22) Filed: Mar. 28, 2003

(51) Int. Cl. E05B 1/00

(52) U.S. Cl. 16/422

(57) ABSTRACT

A one-piece design clip-on handle that is removable from the container and reusable is disclosed. The clip-on handle can be used to securely hold all types of containers either with or without a lip at its opening. The clip-on handle is shaped generally in the shape of an enclosed loop with a protruding end that hooks onto the inside edge of the container while the other end presses against the outside edge of the container to retain the clip-on handle on the container until removed by the user.

### BACKGROUND—FIELD OF INVENTION

The present invention relates generally to a handle for securely holding a container. More specifically, the present invention relates to a removable and reusable handle for securely holding a container.

### BACKGROUND—DESCRIPTION OF RELATED ART

With the exception of some very small containers, containers that are designed to be portable usually have holding means for the user to pick-up and hold the container. The holding means may be incorporated into the design of the container, such as indentations or holes for the user's hand to grasp. More commonly, the holding means is a protrusion from the container in the form of a handle. The protrusion may be a loop or a member for the user to grasp with his/her hand.

Generally, the holding means is part of the container and cannot be removed or reused and must be disposed of along with the container. Furthermore, since the holding means is part of the container, it is of a predetermined fixed size and configuration for “average” sized hands. The predetermined fixed size and configuration may not be comfortable or convenient for users with either larger than average or smaller than average hands.

In addition, some containers may not have a holding means built-in either because of a poor design or because of the additional costs involved in adding a handle to the container. Some containers have holding means that are not comfortable or convenient for the user. Examples of these containers include paint cans and cups with a handle that is either too small or too large.

### SUMMARY OF THE INVENTION

The present invention is a clip-on handle that is removable from the container and reusable. The clip-on handle is a one-piece design with no loose parts. The clip-on handle can be used to securely hold all types of containers either with or without a lip at its opening. The clip-on handle is shaped generally in the shape of a closed loop with a protruding end that hooks onto the inside edge of the container while the other end presses against the outside edge of the container to retain the clip-on handle on the container until removed by the user.

### BRIEF DESCRIPTION OF THE DRAWINGS

FIG. 1 shows a perspective view of the clip-on handle.

FIG. 2 shows the clip-on handle being used to hold a container.

### DETAILED DESCRIPTION OF THE PREFERRED EMBODIMENT

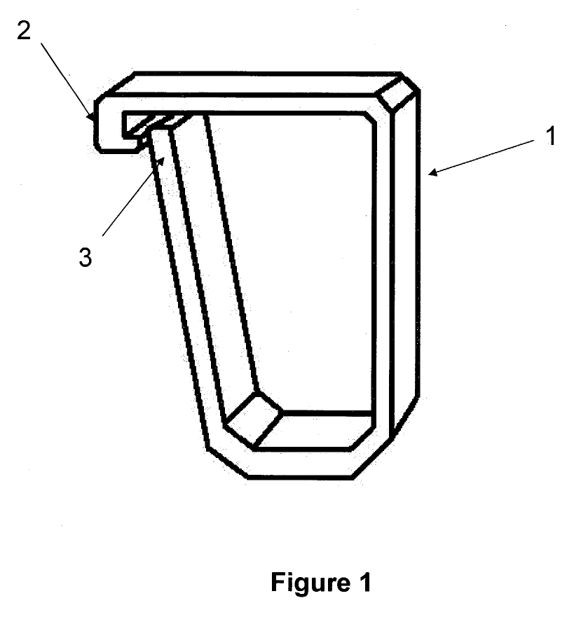

A perspective view of the preferred embodiment of the one-piece design of the clip-on handle 1 is shown in FIG. 1. The clip-on handle 1 may be made of a relatively rigid material such as steel, aluminum, ABS plastic, or other suitable material with sufficient strength to support the weight of the container and its contents without undue deformation. The clip-on handle 1 is generally in the shape of a closed loop with the two ends 2, 3 meeting near one of its top corner. The upper end 2 protrudes beyond the lower end 3 and terminates with a bent inward towards the lower end 3.

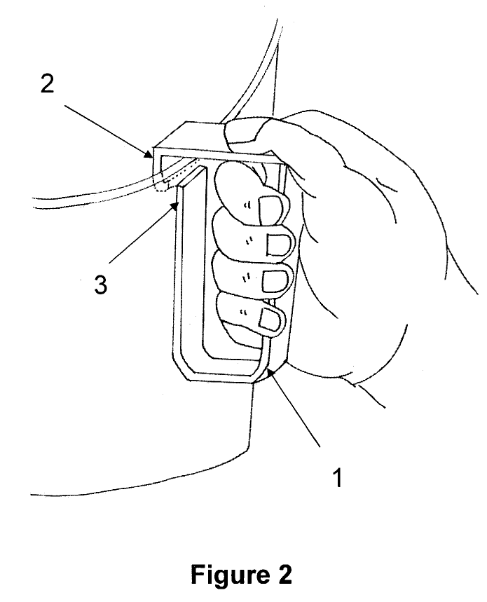

As shown in FIG. 2, the clip-on handle 1 clips securely onto the top edge of the container to be held by engaging the bent end at the upper end 2 to the inside top edge of the container while the lower end 3 flexes to urge the clip-on handle 1 towards the outside surface of the container to securely retain the clip-on handle 1 to the container.

After the clip-on handle 1 is securely engaged to the container, the container may be moved by simply holding and maneuvering the clip-on handle 1. When the clip-on handle 1 is no longer required, the clip-on handle 1 may be easily removed from the container by tilting the clip-on handle 1 upward and toward the top center of the container. The clip-on handle 1 may be cleaned and reused after removal either on the same container again or on another container.

The clip-on handle 1 may be designed with various shapes and sizes to comfortably fit hands of different sizes and for different size containers.

Although the description above contains many specificities, these should not be construed as limiting the scope of the invention but as merely providing illustrations of some of the presently preferred embodiments of this invention. Thus the scope of the invention should be determined by the appended claims and their legal equivalents, rather than by the examples given.

What is claimed is:

1. A clip-on handle comprising a rigid strip in the shape of a closed loop with an upper end that terminates with a bend towards the center of the closed loop and a lower end that terminates approximately at the bend of the upper end wherein the clip-on handle may be removably attached to a container securely to be used as a handle to hold the container.

2. A clip-on handle according to claim 1, wherein the rigid strip is made of aluminum.

3. A clip-on handle according to claim 1, wherein the rigid strip is made of steel.

4. A clip-on handle according to claim 1, wherein the rigid strip is made of ABS plastic.

5. A clip-on handle comprising a rigid strip in the shape of a closed loop with an upper end that terminates with a bend in the shape of a hook towards the center of said closed loop and a lower end that terminates approximately at the bend of the upper end wherein the clip-on handle may be removably attached to a container securely to be used as a handle to hold the container.

6. A clip-on handle according to claim 5, wherein the rigid strip is made of aluminum.

7. A clip-on handle according to claim 5, wherein the rigid strip is made of steel.

8. A clip-on handle according to claim 5, wherein the rigid strip is made of ABS plastic.
